(19) United States
(12) Patent Application Publication
(10) Pub. No.: US 2012/0168232 A1
(43) Pub. Date: Jul. 5, 2012

(54) LOCALIZED FEATURES AND MANUFACTURING METHODS FOR INSERTS OF ROCK BITS

(75) Inventors: Zhou Yong, Spring, TX (US); Sike Xia, Houston, TX (US); Jianhui Xu, Spring, TX (US)

(73) Assignee: SMITH INTERNATIONAL, INC., Houston, TX (US)

(21) Appl. No.: 13/292,675

(22) Filed: Nov. 9, 2011

Related U.S. Application Data
(60) Provisional application No. 61/413,143, filed on Nov. 12, 2010.

(51) Int. Cl. E21B 10/36; B29C 39/38; B29C 39/10; C04B 35/56

(52) U.S. Cl. 175/428; 264/642; 264/332; 264/432; 264/434

(57) ABSTRACT

An insert for a drill bit and method of making an insert is disclosed herein. An insert has a grip region, a cutting extension having a cutting surface, and at least one implant embedded in the cutting extension, wherein the cutting extension comprises a first carbide material and the implant comprises a second carbide material, and wherein the second carbide material has a hardness that is greater than the first carbide material.

### CROSS-REFERENCE TO RELATED APPLICATIONS

This application claims priority to U.S. application Ser. No. 61/413,143, filed on Nov. 12, 2010, which is herein incorporated by reference in its entirety.

### BACKGROUND OF INVENTION

1. Field of the Invention

Embodiments disclosed herein relate generally to inserts for drill bits. In particular, embodiments disclosed herein relate to inserts and methods of forming inserts made of carbide composite materials.

2. Background Art

In a typical drilling operation, a drill bit is rotated while being advanced into a soil or rock formation. The formation is cut by cutting elements on the drill bit, and the cuttings are flushed from the borehole by the circulation of drilling fluid that is pumped down through the drill string and flows back toward the top of the borehole in the annulus between the drill string and the borehole wall. The drilling fluid is delivered to the drill bit through a passage in the drill stem and is ejected outwardly through nozzles in the cutting face of the drill bit. The ejected drilling fluid is directed outwardly through the nozzles at high speed to aid in cutting, flush the cuttings, and cool the cutter elements.

There are several types of drill bits, including roller cone bits, hammer bits, and drag bits. Roller cone rock bits include a bit body adapted to be coupled to a rotatable drill string and include at least one “cone” that is rotatably mounted to a cantilevered shaft or journal as frequently referred to in the art. Each roller cone in turn supports a plurality of cutting elements that cut and/or crush the wall or floor of the borehole and thus advance the bit. The cutting elements, either inserts or milled teeth, contact with the formation during drilling. Hammer bits typically include a one piece body with having crown. The crown includes inserts pressed therein for being cyclically “hammered” and rotated against the earth formation being drilled.

Depending on the type and location of the inserts on the bit, the inserts perform different cutting functions, and as a result, also experience different loading conditions during use. Two kinds of wear-resistant inserts have been developed for use as inserts on drill bits: tungsten carbide inserts and polycrystalline diamond enhanced inserts. Tungsten carbide inserts are typically formed of cemented tungsten carbide (also known as sintered tungsten carbide): tungsten carbide particles dispersed in a cobalt binder matrix. A polycrystalline diamond enhanced insert typically includes a cemented tungsten carbide body as a substrate and a layer of polycrystalline diamond (“PCD”) directly bonded to the tungsten carbide substrate on the top portion of the insert. An outer layer formed of a PCD material can provide improved wear resistance, as compared to the softer, tougher tungsten carbide inserts. However, PCD or other superhard cutting elements often fail from chipping and/or delamination due to the differences in coefficients of thermal expansion, elastic moduli, and bulk compressibilities between the carbide and superhard material.

In composites formed with tungsten carbide, for example, the resulting composite includes the hard particle surrounded by metal binder, typically cobalt or cobalt-based alloys, which acts as a matrix. The individual hard particles thus are embedded in a matrix of a relatively ductile metal such that the ductile metal matrix provides the necessary toughness, while the grains of hard material in the matrix furnish the necessary wear resistance. The ductile metal matrix also reduces crack formation and suppresses crack propagation through the composite material once a crack has been initiated. Among the types of tungsten carbide particles that may be used to form a tungsten carbide composite, for example, include cast tungsten carbide, macro-crystalline tungsten carbide, carburized tungsten carbide, and cemented tungsten carbide.

Many factors affect the durability of a tungsten carbide composite in a particular application. These factors include the chemical composition and physical structure (size and shape) of the carbides, the chemical composition and microstructure of the matrix metal or alloy, and the relative proportions of the carbide materials to one another and to the matrix metal or alloy. For example, a tungsten carbide cobalt composite (which may also be referred to as a type of cermet) is commonly classified by grades based on the grain size of WC and the cobalt content and is primarily made in consideration of two factors that influence the lifetime of the tungsten carbide cutting structure: wear resistance and toughness. As a result, cutting elements known in the art are generally formed of tungsten carbide with average grain sizes about less than 7 μm as measured by ASTM E-112 method, cobalt contents in the range of about 6-16% by weight, and hardness in the range of about 86 to 91 Ra. Generally, as the tungsten carbide particle size and/or metal matrix content decrease, higher hardness, compressive strength, and wear resistance, but lower toughness is achieved. Conversely, larger particle sizes and/or higher metal matrix content yields high toughness and impact strength, but lower hardness.

However, low fracture toughness of tungsten carbide cermets may sometimes be a limiting factor in more demanding applications, such as inserts in roller cone rock bits, hammer bits and drag bits used for subterranean drilling and the like. It is possible to increase the toughness of the tungsten carbide cermet by increasing the amount of cobalt present in the composite. The toughness of the composite mainly comes from plastic deformation of the cobalt phase during the fracture process. Yet, the resulting hardness of the composite decreases as the amount of ductile cobalt increases. In most commonly used tungsten carbide cobalt grades, cobalt is no more than about 20 percent by weight of the total composite.

Further, tungsten carbide is still relatively tougher than diamond or other superhard materials used to form inserts, and external loads and excessive wear from drilling tend to cause failures in tungsten carbide inserts. Breakage and wear of inserts may cause substantial problems in drilling operations, resulting in reduced drilling activity. It is, therefore, desirable that an insert structure be constructed that provides desired properties of hardness and wear resistance with improved properties of fracture toughness for use in aggressive drilling applications.

### SUMMARY

In one aspect, embodiments of the present disclosure relate to an insert that includes a grip region, a cutting extension having a cutting surface, and at least one implant embedded in the cutting extension, wherein the cutting extension comprises a first carbide material and the implant comprises a second carbide material, and wherein the second carbide material has a hardness that is greater than the first carbide material.

In another aspect, embodiments disclosed herein relate to a method of manufacturing an insert for a drill bit that includes providing a mold for the insert, wherein the mold has a cutting extension end and a grip region end, placing at least one implant in the cutting extension end of the mold, pouring a first carbide material in the mold around the at least one implant, and sintering the first carbide material and the at least one implant to form the insert, wherein the at least one implant comprises a second carbide material that is harder than the first carbide material.

In yet another aspect, embodiments disclosed herein relate to a method of manufacturing an insert for a drill bit that includes forming a tip from a first carbide material and forming a base from the first carbide material. The tip includes a cutting surface, a tip interface surface, and a tip receiving cavity disposed in the tip interface surface, and the base includes a grip region, a base interface surface, and a base receiving cavity disposed in the base interface surface. The method further includes assembling the tip and the base around an implant, wherein the implant is disposed between the tip receiving cavity and the base receiving cavity, and sintering the assembly to form the insert, wherein the insert comprises a cutting extension that extends from the grip region to the cutting surface, and wherein the implant comprises a second carbide material that is harder than the first carbide material.

Other aspects and advantages of the invention will be apparent from the following description and the appended claims.

### BRIEF DESCRIPTION OF DRAWINGS

FIG. 1 illustrates a conventional microstructure of a tungsten carbide/metal composite.

FIG. 2 is a cross-sectional view of an insert according to embodiments of the present disclosure.

FIG. 3 is a cross-sectional view of an insert according to embodiments of the present disclosure.

FIG. 4 shows an insert according to embodiments of the present disclosure.

FIG. 5 is a cross-sectional view of an insert according to other embodiments of the present disclosure.

FIGS. 6A and 6B show methods according to embodiments of the present disclosure of forming an insert having at least one implant embedded therein.

FIG. 7 shows a method according to other embodiments of the present disclosure for forming an insert having at least one implant embedded therein.

FIG. 8 shows another method according to embodiments of the present disclosure of forming an insert having at least one implant embedded therein.

FIG. 9 shows a roller cone bit on which an insert according to embodiments of the present disclosure may be disposed.

FIG. 10 shows a hammer bit on which an insert according to embodiments of the present disclosure may be disposed

### DETAILED DESCRIPTION

Embodiments disclosed herein relate to tungsten carbide inserts for use in earth boring drill bits, such as for geothermal or oil and gas drilling, for example, and methods of manufacturing tungsten carbide inserts. In particular, the inserts of the present disclosure may be made of a first tungsten carbide material and have at least one implant embedded therein. The at least one implant may be made of a second tungsten carbide material that is harder than the first tungsten carbide material.

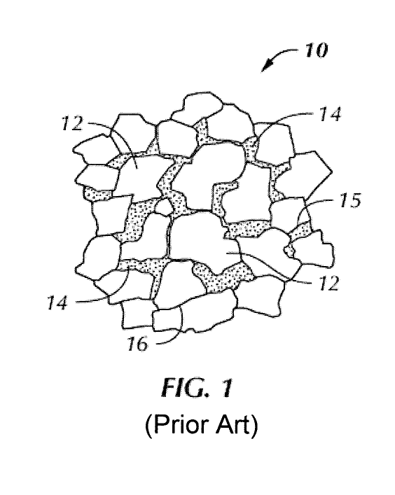

FIG. 1 illustrates the conventional microstructure of tungsten carbide/metal composite. As shown in FIG. 1, cemented tungsten carbide 10 includes tungsten carbide grains 12 that are bonded to one another by a metal binder phase 14. As illustrated, tungsten carbide grains may be bonded to other grains of tungsten carbide (depending on the metal content), thereby having a tungsten carbide/tungsten carbide interface, and/or may be bonded to the metal phase, thereby having a tungsten carbide/metal interface. The unique properties of tungsten carbide composites result from this combination of hard carbide particles with a tougher, ductile metal phase. The toughness of a tungsten carbide composite may be increased by increasing the amount of metal binder present in the composite and/or by increasing the carbide grain size. Conversely, the hardness of a tungsten carbide composite may be increased by decreasing the amount of metal binder and/or be decreasing the carbide grain size. Thus, in a harder tungsten carbide material having decreased amounts of metal binder, there may be an increased amount of tungsten carbide/tungsten carbide interfaces.

As used herein, a first carbide material that may be used to form an insert of the present disclosure may include tungsten carbide grains bonded together with a metal binder selected from at least one element in Group VIII of the Periodic Table, such as cobalt. The first carbide material may have a hardness ranging from 85 to 92 HRa. The hardness of the first carbide material may be engineered by controlling the grain size of the tungsten carbide and the metal binder content. In particular, the grain size and/or the binder content may be increased to increase the toughness of the first carbide material. For example, the first carbide material may have an average tungsten carbide grain size ranging from about 1 micron to about 14 microns and an average binder content ranging from about 6% to 20% by volume.

A second carbide material that may used to form at least one implant may include a plurality of tungsten carbide grains bonded together with a metal binder selected from at least one element in Group VIII of the Periodic Table, wherein the resulting tungsten carbide composite is harder than the first carbide material. In exemplary embodiments, the grain size and/or binder content may be decreased to increase the hardness of the second carbide material, such that the hardness of the second carbide material is harder than the first carbide material by at least 0.5 HRa in one embodiment and by at least 2.7 HRa in another embodiment. For example, the second carbide material may have an average tungsten carbide grain size smaller than the first carbide material and ranging from about 0.2 microns to about 6 microns and/or an amount of metal binder less than the first carbide material and ranging from about 3% to 10% by volume. As used herein, the difference in hardness values between the first and second carbide materials is determined by measuring the hardness value of each individual material after full sintering (i.e., the first and second carbide materials are sintered individually to measure each material's hardness value), rather than after the first and second carbide materials have been sintered together to form a final insert.

Furthermore, embodiments of the present disclosure may have at least one implant that is completely surrounded by the first carbide material and/or at least one implant that is surrounded by the first carbide material except for at an exposed surface. Advantageously, the first carbide material may act as a support for an implant, and may exert compressive forces around the implant during drilling operations. In particular, the design combining a harder implant with a tougher surrounding insert material may be configured such that the implant is pre-compressed during manufacture by the different thermal expansion properties of the two materials. Upon applying contact pressure to the insert from drilling operations, the implant may undergo a fully compressed state, in which the chipping or fracture resistance of the implant may be improved significantly or the hardness of the tip may be increased considerably without the concern of loss of toughness. Thus, while excessive loading experienced during drilling may lead to failure in conventional tungsten carbide inserts, such as through crack propagation between carbide/carbide grain interfaces (which may be more common in harder tungsten carbide material having decreased amounts of metal binder), a harder implant surrounded by a tougher insert material may provide improved crack resistance. Specifically, by providing compressive forces around the implant, crack propagation may be reduced or prevented, and thus better performance of penetration rate and durability may be achieved.

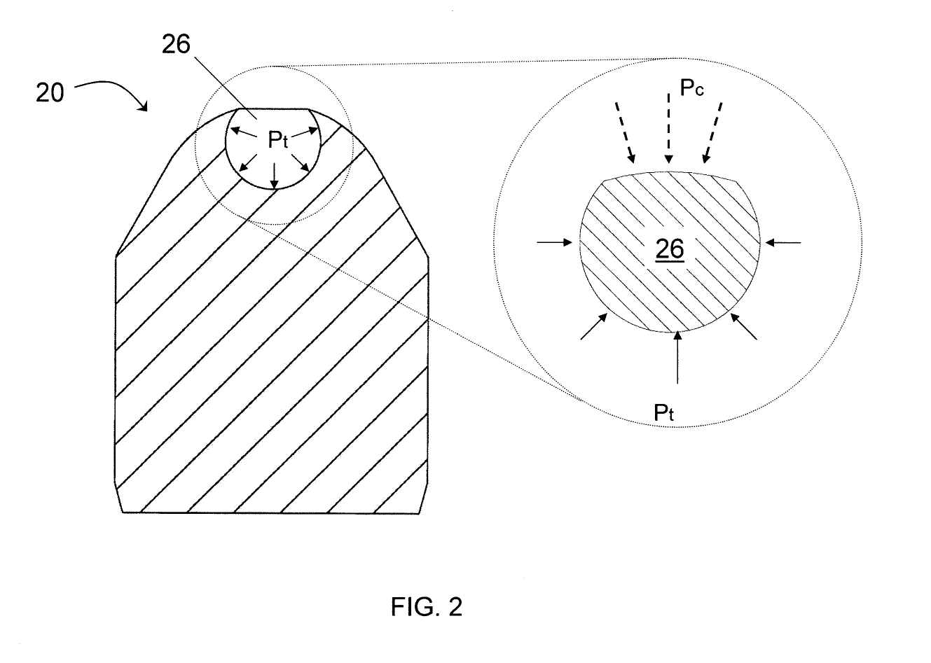

Referring to FIG. 2, loading P_{c} and compressive Pₜ forces are shown in an exemplary embodiment of an insert 20 with an implant 26 embedded therein, according to embodiments of the present disclosure. The weight of the drill bit and contact between the insert 20 and a working surface (not shown), for example, may exert loading forces P_{c} on the insert 20, and in particular, on the implant 26. Such loading may be distributed around the implant by surrounding the entire implant, or the entire implant except for at an exposed surface, with a tougher tungsten carbide material. The surrounding tougher tungsten carbide material may also provide compressive forces Pₜ, which may act to reduce crack propagation through the harder tungsten carbide material of the implant 26.

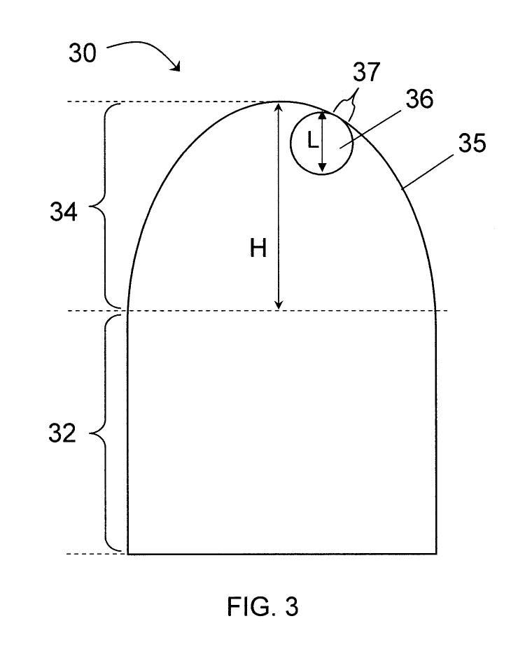

Referring now to FIG. 3, a cross-sectional view of an insert 30 according to the present disclosure is shown. The insert 30 has a grip region 32 and a cutting extension 34, wherein at least the cutting extension 34 may be made of a first carbide material. The cutting extension 34 has a cutting surface 35 that may contact and cut a working surface. As shown, at least one implant 36 is embedded in the cutting extension 34, wherein the implant 36 may be made of a second carbide material that has a hardness value greater than the first carbide material. For example, the hardness of the second carbide material may be greater than the hardness of the first carbide material by at least 0.5 HRa. Although shown as a sphere in FIG. 3, an implant may take other shapes. For example, an implant may be have multiple intersecting planar surfaces, curved surfaces, or a combination of planar and curved surfaces, or have other irregular shapes.

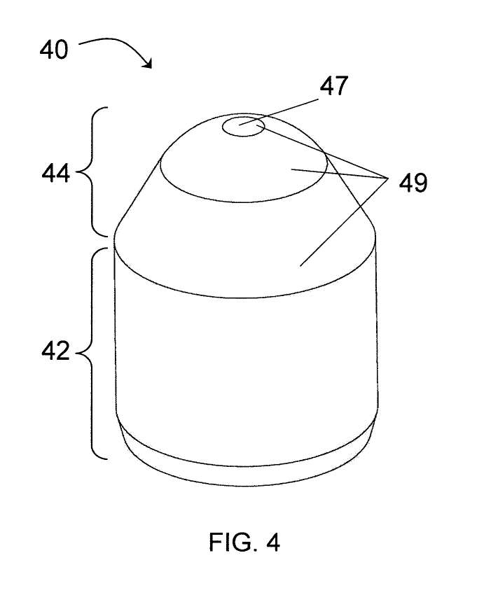

Further, as shown in FIGS. 3, the implant 36 is surrounded on all surfaces by the first carbide material of the cutting extension 34 except for at an exposed surface 37, wherein the exposed surface 37 forms a portion of the cutting surface 35. In embodiments having an exposed surface, the exposed surface may have the same radius of curvature as the surrounding cutting surface so that the exposed surface is substantially flush with the cutting surface. FIG. 4 shows another embodiment of an insert 40 having a cutting extension 44, a grip region 42, and at least one implant embedded within the cutting extension. The at least one implant has an exposed surface 47 that forms a portion of the cutting extension surface 49. According to embodiments disclosed herein, an implant with an exposed surface may have an area ratio equal to the exposed surface area to the total surface area of the cutting extension. For example, as seen in FIG. 4, an implant may have an area ratio of the exposed surface area 47 to the total surface area of the cutting extension 49 that ranges from greater than 0 to about 10%, and preferably from about 2 to about 5%.

According to the present disclosure, the exposed surface of an implant may also be measured in relation to the total surface area of the implant. In some embodiments, a ratio of the exposed surface area to the total surface area of an implant may range from 0 to about 35%, and preferably from about 10 to 30%.

The amount of implant material embedded within inserts of the present disclosure may also be limited by volume percent and by position within the cutting extension of the insert. In particular, the amount of force generated by the surrounding insert material may be dependent on a volume ratio of the size of the at least one implant to the volume of the cutting extension of the insert. Thus, the size of the implant(s) may be designed to be small enough (e.g., measured by the radius of a sphere) that sufficient compressive forces are provided around the implant to reduce or prevent crack propagation. For example, an insert according to some embodiments may have at least one implant embedded therein, wherein the at least one implant comprises a volume ratio ranging from about 0.5% to 17% of the volume of the cutting extension. Additionally, as shown in FIG. 3, an insert 30 may have at least one implant 36 embedded within the cutting extension 34, wherein the at least one implant 36 has a length L that is not larger than 55% of the cutting extension height H. As used herein, the length of an implant refers to the longest part of the implant. For example, the length of the implant shown in FIG. 3 may be measured in any dimension because the implant is spherical. In embodiments having a non-spherical shape, the length L is measured along the longest dimension of the implant.

Using implants within the size limitations described herein may provide several advantages over using larger implants. For example, if an insert has large implants, the compressive stress magnitude on the implant may be negligible due to the lack of the surrounding insert material to generate sufficient thermal mismatch loading (represented as Pₜ in FIG. 2). Also, reaction pressure (from thermal mismatch loading) on the insert with large implants may lead to tensile stress along the interface, which may initiate cracks or weaken the strength of the substrate during drilling. For example, when contact loading (represented as P_{c} in FIG. 2) is applied to a larger implant, the insert may not have enough surrounding insert material to maintain structural integrity.

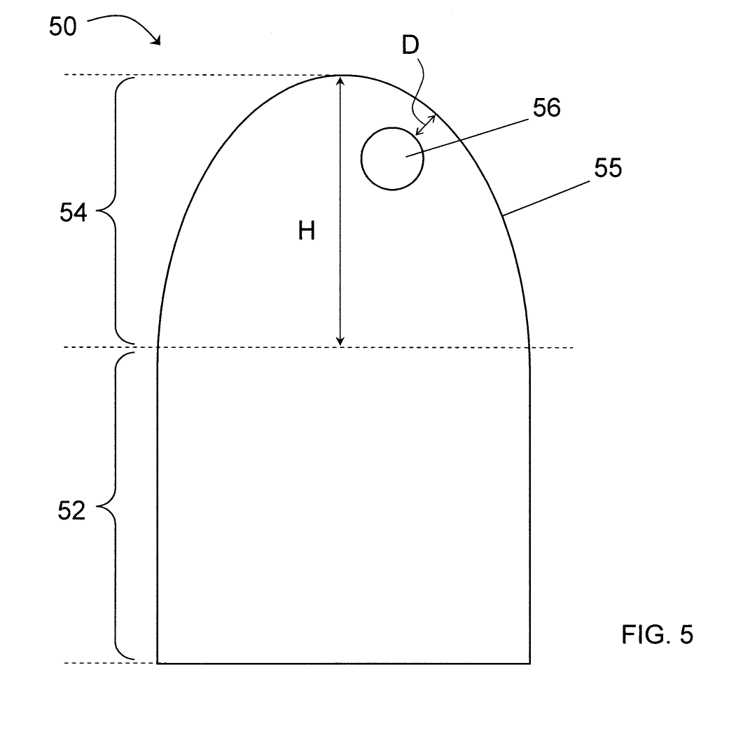

According to other embodiments of the present disclosure, an insert made of a first carbide material may have at least one implant embedded therein, wherein the at least one implant is completely surrounded by the first carbide material. For example, FIG. 5 shows a cross-sectional view of an insert 50 having a grip region 52 and a cutting extension 54, wherein at least the cutting extension 54 may be made of a first carbide material. The cutting extension 54 has a cutting surface 55 that may contact and cut a working surface. As shown, at least one implant 56 is embedded in the cutting extension 54, wherein the implant 56 may be made of a second carbide material that has a hardness value greater than the first carbide material. For example, the hardness of the second carbide material may be greater than the hardness of the first carbide material by at least 0.5 HRa. Further, the implant 56 may be completely surrounded by the first carbide material of the cutting extension 54. In particular, the implant 56 may be embedded within the cutting extension 54 a distance D beneath the cutting surface 55 of the insert 50. As shown in FIG. 5, the implant 56 may be embedded within the insert 50, such that the maximum distance D from the cutting surface 55 of the insert 50 to the implant 56 is less than about 0.05 inches, and preferably less than 0.03 inches.

Methods of forming inserts of the present disclosure may include, but are not limited to, using a dual hot isostatic pressing (“HIP”) and high pressure, high temperature (“HPHT”) process. Other sintering process that may be used include rapid omnidirectional compaction (“ROC”), vacuum sintering, microwave sintering, and spark plasma sintering (SPS), electrical discharge compaction, and sinter-HIP processing.

HIP, as known in the art, is described in, for example, U.S. Pat. No. 5,290,507, which is herein incorporated by reference in its entirety. Isostatic pressing generally is used to produce powdered metal parts to near net sizes and shapes of varied complexity. Hot isostatic processing is performed in a gaseous (inert argon or helium) atmosphere contained within a pressure vessel. Typically, the gaseous atmosphere and the powder to be pressed are heated by a furnace within the vessel. Common pressure levels for HIP may extend upward to 45,000 psi with temperatures up to 3000° C. For tungsten carbide composites, typical processing conditions include temperatures ranging from 1200-1450° C. and pressures ranging from 800-1,500 psi. In the hot isostatic process, the powder to be hot compacted is placed in a hermetically sealed container, which deforms plastically at elevated temperatures. Prior to sealing, the container is evacuated, which may include a thermal out-gassing stage to eliminate residual gases in the powder mass that may result in undesirable porosity, high internal stresses, dissolved contaminants and/or oxide formation. In addition to the traditional WC or low pressure sintering process, the composites of the present disclosure may also be subjected to at least one high pressure process, i.e., pressures upwards of 100,000 psi.

Examples of HPHT processes can be found, for example, in U.S. Pat. Nos. 4,694,918; 5,370,195; 4,525,178; 5,676,496 and No. 5,598,621. HPHT processes may involve pressures up to 1,100,000 psi and temperatures up to 1600° C.; however, the conditions may generally range from 1200-1500° C. and 500,000-1,000,000 psi. While certain pressures and temperatures may be used in HPHT processing to form polycrystalline diamond, because the present application is not focused on the formation of diamond, there may be greater flexibility in the selection of temperature and pressure. Generally, in HPHT sintering, an unsintered mass of particles is placed within a metal enclosure of the reaction cell of a HPHT apparatus. A suitable HPHT apparatus for this process is described in U.S. Pat. Nos. 2,947,611; 2,941,241; 2,941,248; 3,609,818; 3,767,371; 4,289,503; 4,673,414; and 4,954,139. A metal binder, such as cobalt or other Group VIII metals, may be included with the unsintered mass of particles to bond the particles together.

Vacuum sintering, as known in the art, is described in, for example, U.S. Pat. No. 4,407,775, which is herein incorporated by reference in its entirety. The power to be compacted is loaded in an open mold or container for consolidation. The powder is then consolidated by sintering in a vacuum. Suitable pressures for vacuum sintering are about 10⁻³ psi or less. Sintering temperatures must remain below the solidus temperature of the powder to avoid melting of the powder. One of ordinary skill in the art would recognize that in addition to these sintering techniques, other low pressure sintering processes, such as inert gas sintering and hot pressing, are within the scope of the present disclosure.

Examples of microwave sintering processes can be found, for example, in U.S. Pat. No. 5,848,348; 6,126,895; and 6,011,248, which are herein incorporated by reference in their entirety. The carbide composite and the wear resistant materials may be formed by the application of heat, such as by sintering of “green” particles to create intercrystalline bonding between the particles. Briefly, to form a sintered composite, an unsintered mass of particles is placed within an enclosure of the reaction cell. A metal binder, such as cobalt, may be included with the unsintered mass of carbide particles. The reaction cell is then placed under processing conditions sufficient to cause the bonding between the carbide particles and binding material. Suitable processing conditions may include a temperature ranging from 1200 to 1350° C. for 8-20 minutes, with a total cycle time of less than 2 hours.

Electro-discharge compaction (EDC) involves a compaction process using an apparatus having a bank of capacitors to apply a high-voltage, high density current pulse to a powder column subjected to external pressure (such as around 30,000 psi), where the current pulse generates resistive heating of the powder by a Joule effect.

Rapid omnidirectional compaction (ROC), such as that described in U.S. Pat. No. 6,106,957, which is herein incorporated by reference in its entirety, involves a powder metal workpiece preform disposed in a ceramic shell or envelope. The perform is heated to a desired elevated temperature and then placed in a pressure vessel and pressurized to compact the preform. The ceramic shell acts as a liquid die material and, when placed in a suitable pressure vessel and pressurized such as by the use of a hydraulic ram, the ceramic material is rapidly pressurized in a short time interval. The preform is thus rapidly isodynamically pressurized and consolidated.

Sinter-HIPing is also referred to as over-pressure sintering. In sinter-HIP, the chamber containing green bodies of tungsten carbide and binder is first heated to sintering temperature and is then pressurized. Compared with conventional HIP, sinter-HIP uses lower pressures and higher temperatures, such as temperatures of 1400° C. and pressures of about 800 psi.

SPS-sintering is a process that includes sintering in the presence of an electric-field. One method of performing SPS is by passing a pulsewise DC electric current through a dry powder mixture or through a pre-formed compact, while applying pressure that may range from 1500 psi to 30,000 psi.

In particular, according to embodiments disclosed herein, a preformed insert may be formed using HIP, and the preformed insert may then be subjected to HPHT conditions. Although the pressure conditions in HIP are generally too low to form diamond, such as for forming conventional inserts having diamond, inserts of the present disclosure that are made entirely of carbide may undergo HIP prior to HPHT processing to densify the sintered insert and minimize fracture initiating voids. Thus, because inserts of the present disclosure are made entirely of carbide, the inserts may be formed using a dual HIP and HPHT processing. However, in other embodiments, inserts of the present disclosure may be formed using any of the processes described herein.

Furthermore, inserts having implants therein may be formed by separately preparing the material for each of the at least one implant and the remaining insert material and integrating the at least one implant and the remaining insert material together through packing and sintering methods described herein. In addition to HIP and HPHT sintering, other sintering methods that may be used include vacuum sintering, ROC, microwave sintering, and SPS, for example.

In an embodiment, the assembled implant and surrounding insert material may be subjected to at least two separate press or sintering processes, where the first process in time is performed at a lower pressure than the second process in time. In a particular embodiment, the first process may have a pressure less than about 30,000 psi, and less than about 10,000 psi in another embodiment, and may be even pressure-less in another embodiment. In a particular embodiment, the second process may have a pressure greater than the first process, which may include pressures of greater than about 800 psi or greater than about 10,000 psi in another embodiment, and up to 1,100,000 psi in another embodiment. When the second process involves pressures on the lower end of the range, such as 800 psi, one of ordinary skill in the art would appreciate, after consideration of the present disclosure, that such pressures may be used in the second, higher pressure process when an even lower pressure or pressure-less process used as the first process. The low (or lower) pressure process may be performed initially to sinter the implant and surrounding insert material together without significant binder migration between the two regions of the insert. While such lower pressure process may allow for bonding without significant binder migration, it may result in a higher porosity product. The porosity may be reduced by a sequential higher pressure process. Thus, for example, a microwave sintering process may be used as a first process, and a HIP process or a ROC may be used as a second, sequential process. In another example, a SPS sintering process may be used as the first process, and a HIP process or a ROC may be used as a second, sequential process. In another example, an electrical discharge compaction process may be used as the first process, and a HIP process or a ROC may be used as a second, sequential process. In yet another example, a sinter-HIP process may be used as the first process, and a HIP process or a ROC may be used as a second, sequential process. Further, the first process may include any of microwave sintering, vacuum sintering, SPS, electro-discharge compaction, sinter-HIP, HIP, and ROC, and the second process may include any of sinter-HIP, SPS, HIP, ROC, or HPHT sintering, where the first process and the second process are not the same, and in particular embodiments, the first process may have a lower pressure than the second process.

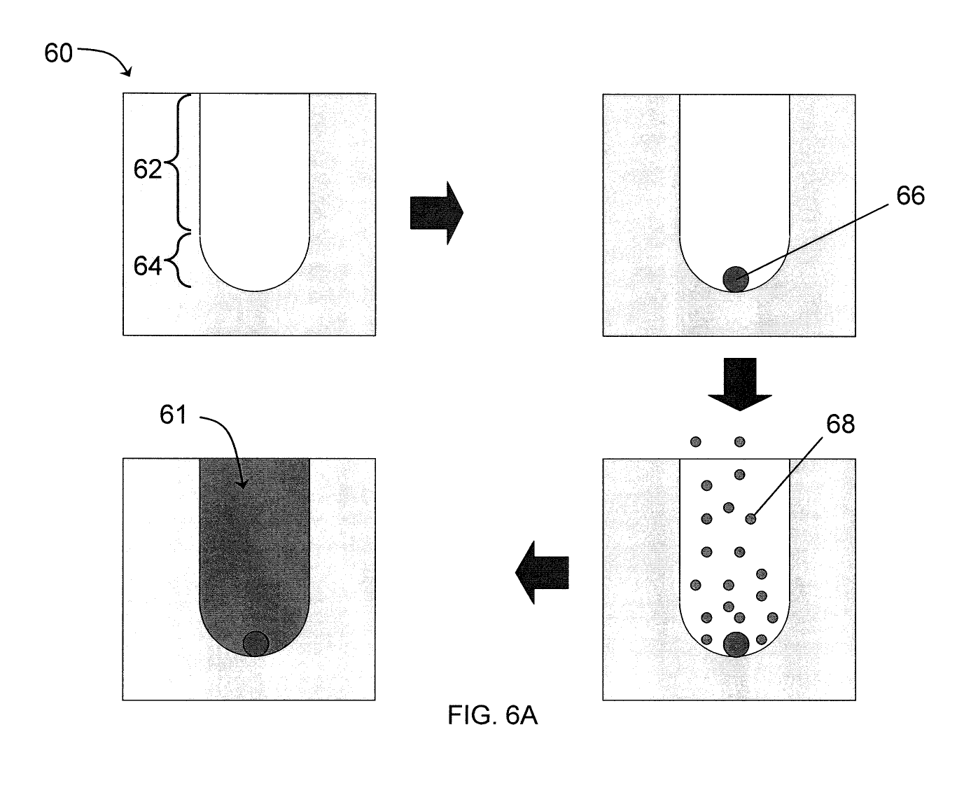

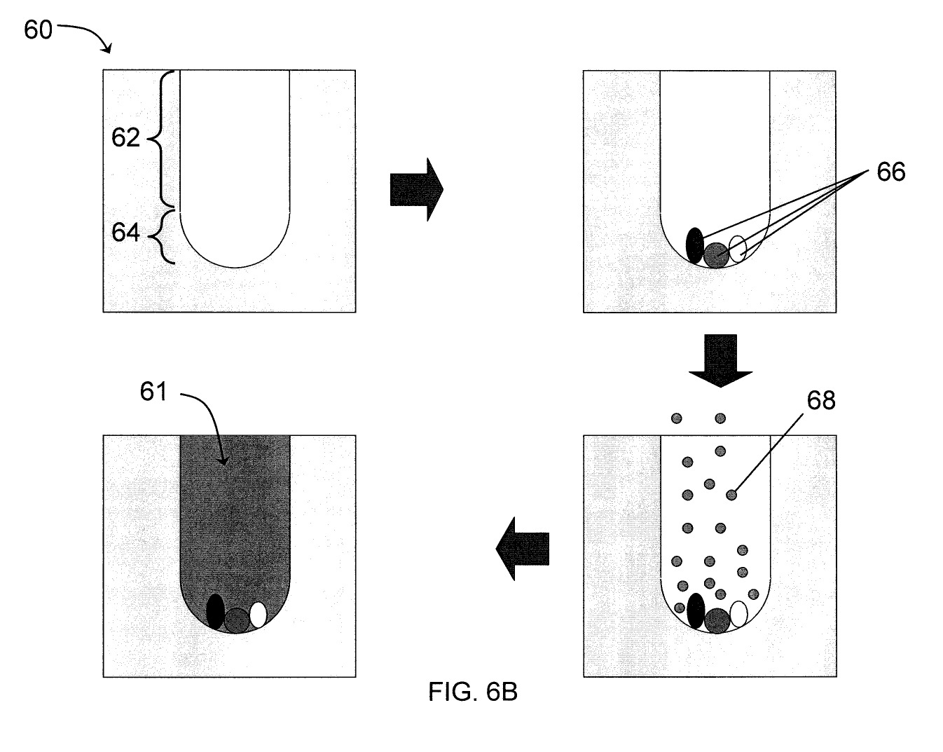

Referring now to FIGS. 6A and 6B, a method of manufacturing an insert for a drill bit is shown. As shown, a mold 60 for an insert 61 is provided, wherein the mold 60 has a cutting extension end 64 and a grip region end 62. At least one implant 66 is placed in the cutting extension end 64 of the mold 60. A first carbide material 68 is then placed in the mold 60 around the at least one implant 66. As shown in FIGS. 6A and 6B, the first carbide material 68 may be introduced into the mold 60 in powder form. The at least one implant 66 may be formed prior to formation of the insert 61 by cementing or pressing a second carbide material into the implant shape, wherein the second carbide material of the at least one implant is harder than the first carbide material. The first carbide material and the at least one implant may then be sintered together to form the insert 61. According to some embodiments, the first carbide material and the at least one implant may be sintered together by subjecting the first carbide material and the at least one implant to HPHT conditions. In other embodiments, the first carbide material and the at least one implant may be sintered together using both HIP and HPHT processing. In particular, the first carbide material and the at least one implant are subjected to HIP to form a preformed insert. The preformed insert may then be subjected to HPHT conditions to form the insert.

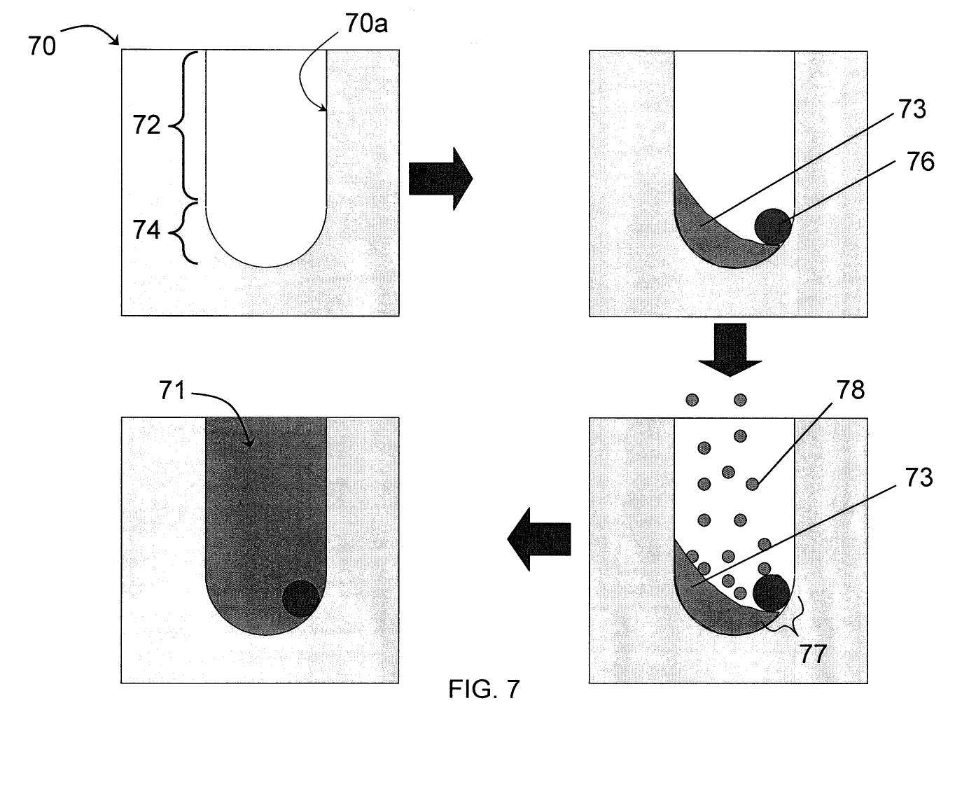

Further, the at least one implant may be positioned in the cutting extension end of the mold at various locations along the mold wall by using pre-formed pieces to hold the at least one implant in the desired location. For example, as shown in FIG. 7, a mold 70 for an insert has a grip region end 72 and a cutting extension end 74. A pre-formed piece 73 may be placed in the cutting extension end 74 of the mold 70 prior to placing at least one implant 76 in the mold 70. The pre-formed piece 73 may be made by sintering or pressing first carbide material to form a pre-sintered piece shape. The pre-formed piece 73 may then be placed at one side of the mold 70 such that implant 76 rests in a cradle 77 formed between the pre-formed piece 73 and the mold wall 70a. Powdered first carbide material 78 may then be then placed in the mold 70, over the pre-formed piece 73 and around implant 76.

In inserts formed from the methods described above, at least one implant may be positioned in a mold so that an exposed surface of the implant contacts the mold wall, and first carbide material may be poured in the mold around the implant so that the remaining surface of the implant contacts first carbide material. Once the contents of the mold are sintered and the mold is removed, the exposed surface of the implant is exposed to the outer surface of the insert, thus forming part of the cutting surface. In particular, the first carbide material may surround the entire implant except for the exposed surface (i.e., the portion of the implant that contacts the mold wall), such that the exposed surface may be flush with the cutting surface formed from the first carbide material. According to embodiments of the present disclosure, at least 70% of an implant surface area may be surrounded by the first carbide material, such that an exposed surface of the implant forms greater than 0% but no more than 30% of the implant surface area.

In other embodiments of the present disclosure, the manufacturing process of forming an insert may result in at least one implant being completely surrounded by the first carbide material. In particular, when pouring a powdered first carbide material in a mold and around an implant, the first carbide material may displace the implant from contacting the mold wall. In such embodiments, a layer of first carbide material may be positioned between the implant and the mold wall such that upon formation of the insert, the maximum distance from the cutting surface of the insert to the implant is about 0.05 inches, and more preferably 0.03 inches.

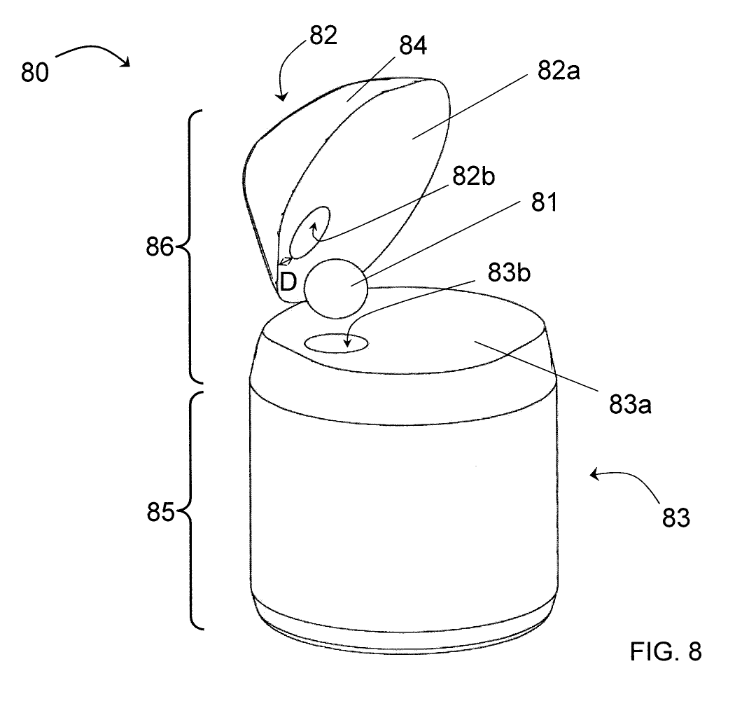

According to other embodiments of the present disclosure, an insert having at least one implant embedded therein may be formed by assembling multiple pre-formed components around the implant and sintering the assembly together. Referring now to FIG. 8, an exemplary embodiment of an insert 80 formed by assembling multiple pre-formed components around an implant 81 is shown. As shown, a tip 82 and a base 83 may be formed by sintering or pressing a first carbide material into a desired shape of the tip 82 and the base 83. In particular, the tip 82 has a cutting surface 84, a tip interface surface 82a, and a tip receiving cavity 82b disposed in the tip interface surface 82a. The base 83 has a grip region 85, a base interface surface 83a, and a base receiving cavity 83b disposed in the base interface surface 83a. Furthermore, an implant 81 may be formed by sintering or pressing a second carbide material into a desired shape, wherein the second carbide material is harder than the first carbide material. The tip receiving cavity 82b and the base receiving cavity 83b correspond to the shape of the implant 81 such that the implant 81 is disposed between the tip and base receiving cavities 82b, 83b and the tip and base interface surfaces 82a, 83a mate when the tip 82 and the base 83 are assembled around the implant 81. The assembly may then be sintered to form an insert 80 having the implant 81 embedded therein.

Further, upon assembly and formation of the insert 80, the insert 80 has a cutting extension 86 extending from the grip region 85 to the cutting surface 84. According to embodiments of the present disclosure, the base 83 also includes a portion of the cutting extension 86. The base receiving cavity 83b is formed in the cutting extension 86 portion of the base 83 such that upon assembly of the implant 81 between the tip and base receiving cavities 82b, 83b, the implant 81 is positioned within the cutting extension 86 of the insert. Advantageously, by assembling pre-formed components of an insert around the implant, the position of the implant within the cutting extension of the insert may be controlled with increased preciseness. In some embodiments, the implant 81 may be formed within a region of the cutting extension that is a distance D from the cutting extension 86 surface.

Furthermore, a tip receiving cavity may extend a depth from the tip interface surface into the pre-formed tip. In some embodiments, the tip receiving cavity may extend a depth into the pre-formed tip such that when an implant is assembled in the tip receiving cavity, the maximum distance from the cutting extension surface to the implant may be about 0.05 inches. In other embodiments, the tip receiving cavity may extend from the tip interface surface to the cutting surface such that when an implant is assembled in the tip receiving cavity, the implant has an exposed surface that forms a portion of the cutting surface. In embodiments with an implant having an exposed surface, an area ratio of the area of the exposed surface may range from about 0.5% to 10% of the total surface area of the cutting surface.

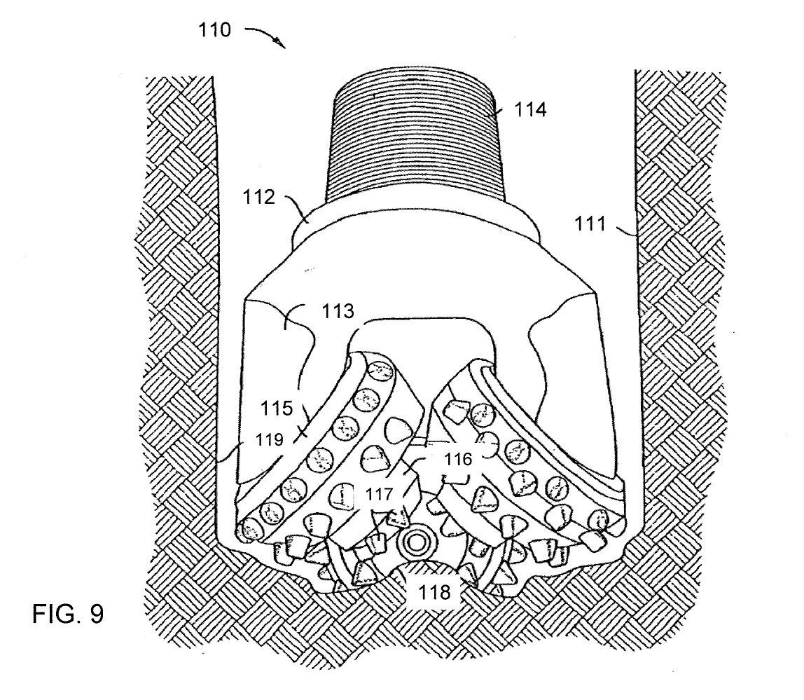

The inserts of the present disclosure may be used, for example, as an insert on a roller cone bit or other downhole tools, such as hammer bits in which tungsten carbide inserts are conventionally used. A roller cone bit is shown in FIG. 9. Roller cone rock bits include a bit body adapted to be coupled to a rotatable drill string and include at least one “cone” that is rotatably mounted to the bit body. Referring to FIG. 9, a roller cone rock bit 110 is shown disposed in a borehole 111. The bit 110 has a body 112 with legs 113 extending generally downward, and a threaded pin end 114 opposite thereto for attachment to a drill string (not shown). Journal shafts (not shown) are cantilevered from legs 113. Roller cones (or rolling cutters) 116 are rotatably mounted on journal shafts. Each roller cone 116 has a plurality of cutting elements 117 mounted thereon. As the body 110 is rotated by rotation of the drill string (not shown), the roller cones 116 rotate over the borehole bottom 118 and maintain the gage of the borehole by rotating against a portion of the borehole sidewall 119. As the roller cone 116 rotates, individual cutting elements 117 are rotated into contact with the formation and then out of contact with the formation. Any of cutting elements 117 may be an insert of the present disclosure; however, in particular embodiments, the inserts of the present disclosure may be used on one of the inner rows of cutting elements 117 or on a gage row.

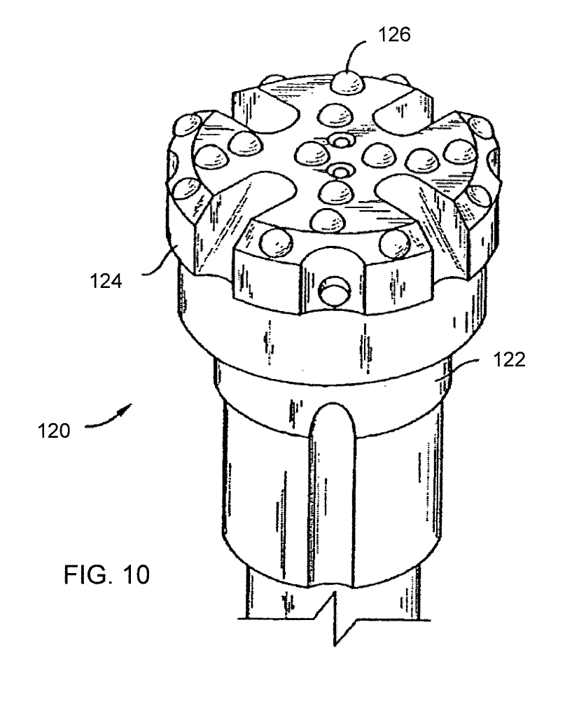

Hammer bits typically are impacted by a percussion hammer while being rotated against the earth formation being drilled. Referring to FIG. 10, a hammer bit is shown. The hammer bit 120 has a body 122 with a head 124 at one end thereof. The body 122 is received in a hammer (not shown), and the hammer moves the head 124 against the formation to fracture the formation. Cutting elements 126 are mounted in the head 124. Typically the cutting elements 126 are embedded in the drill bit by press fitting or brazing into the bit. Any of cutting elements 126 may be an insert of the present disclosure.

Advantageously, by using a carbide material for both the at least one implant and the surrounding insert material, stresses that would otherwise form at the interface between diamond and carbide, for example, are reduced because the coefficients of thermal expansion of the two carbide materials are much closer than the coefficients of thermal expansion of diamond and carbide.

Further, the position of an implant may be selected to provide increased hardness and strength to an insert at a particular location to reduce failure in the insert while undergoing drilling operations. In particular, the interface between the two carbide materials of an implant and the insert may provide increased hardness near the interface.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. An insert for a drill bit, comprising:
a grip region;
a cutting extension having a cutting surface, wherein the cutting extension comprises a first carbide material; and
at least one implant embedded in the cutting extension, wherein the implant comprises a second carbide material;
wherein the second carbide material has a hardness that is greater than the first carbide material.

2. The insert of claim 1, wherein the hardness of the second carbide material is greater than the hardness of the first carbide material by at least 0.5 HRa.

3. The insert of claim 1, wherein all surfaces of at least one implant is surrounded by the first carbide material except for at an exposed surface, wherein the exposed surface forms a portion of the cutting surface.

4. The insert of claim 3, wherein an area ratio of an area of the exposed surface to an area of the cutting surface ranges from about 0.5% to 10%.

5. The insert of claim 1, wherein the at least one implant is completely surrounded by the first carbide material.

6. The insert of claim 5, wherein the maximum distance from the cutting surface to the implant is about 0.05 inches.

7. The insert of claim 1, wherein the at least one implant comprises about 0.5% to 17% of the volume of the cutting extension.

8. The insert of claim 1, wherein the at least one implant has a length that is not larger than 55% of the cutting extension height.

9. The insert of claim 1, wherein the first carbide material and the second carbide material each comprises a plurality of tungsten carbide grains bonded together by a metal binder.

10. The insert of claim 9, wherein the first carbide material comprises tungsten carbide particles ranging in size from about 1 micron to about 14 microns.

11. The insert of claim 9, wherein the second carbide material comprises tungsten carbide particles ranging in size from about 0.2 microns to about 6 microns.

12. The insert of claim 9, wherein the first carbide material has an amount of ductile metal matrix material greater than the second carbide material.

13. A method of manufacturing an insert for a drill bit, comprising:
providing a mold for the insert, wherein the mold has a cutting extension end and a grip region end;
placing at least one implant in the cutting extension end of the mold;
pouring a first carbide material in the mold around the at least one implant; and
sintering the first carbide material and the at least one implant to form the insert;
wherein the at least one implant comprises a second carbide material that is harder than the first carbide material.

14. The method of claim 13, wherein sintering comprises subjecting the first carbide material and the at least one implant to high pressure high temperature conditions.

15. The method of claim 13, wherein sintering comprises:
subjecting the first carbide material and the at least one implant to a first process to form a preformed insert; and
subjecting the preformed insert to second process having a higher pressure than the first process.

16. The method of claim 15, wherein the first process is selected from microwave sintering, spark plasma sintering, electro-discharge compaction, vacuum sintering, sinter-hot isostatic pressing, or hot isostatic pressing.

17. The method of claim 16, wherein the second process is selected from spark plasma sintering, sinter-hot isostatic pressing, hot isostatic pressing, rapid omnidirectional compaction, and HPHT sintering.

18. The method of claim 13, wherein a pre-sintered piece is placed in the cutting extension end of the mold prior to placing the at least one implant in the mold, and wherein the pre-formed piece comprises the first carbide material.

19. The method of claim 13, wherein the hardness of the second carbide material is greater than the hardness of the first carbide material by at least 0.5 HRa.

20. The method of claim 13, wherein the at least one implant is completely surrounded by the first carbide material.

21. The method of claim 13, wherein the at least one implant comprises about 0.5% to about 17% of the volume of the cutting extension end of the mold.

22. The method of claim 13, wherein the at least one implant has a length that is not larger than 55% of the height of the cutting extension end.

23. A method of manufacturing an insert for a drill bit, comprising:
forming a tip from a first carbide material, wherein the tip comprises:
a cutting surface;
a tip interface surface; and
a tip receiving cavity disposed in the tip interface surface;
forming a base from the first carbide material, wherein the base comprises:
a grip region;
a base interface surface; and
a base receiving cavity disposed in the base interface surface;
assembling the tip and the base around an implant, wherein the implant is disposed between the tip receiving cavity and the base receiving cavity; and
sintering the assembly to form the insert, wherein the insert comprises a cutting extension that extends from the grip region to the cutting surface;
wherein the implant comprises a second carbide material that is harder than the first carbide material.

24. The method of claim 23, wherein sintering comprises subjecting the first carbide material and the implant to high pressure high temperature conditions.

25. The method of claim 23, wherein sintering comprises:
subjecting the first carbide material and the at least one implant to a first process to form a preformed insert; and
subjecting the preformed insert to second process having a higher pressure than the first process.

26. The method of claim 25, wherein the first process is selected from microwave sintering, spark plasma sintering, electro-discharge compaction, vacuum sintering, sinter-hot isostatic pressing, or hot isostatic pressing.

27. The method of claim 26, wherein the second process is selected from spark plasma sintering, sinter-hot isostatic pressing, hot isostatic pressing, rapid omnidirectional compaction, and HPHT sintering.

28. The method of claim 23, wherein the hardness of the second carbide material is greater than the hardness of the first carbide material by at least 0.5 HRa.

29. The method of claim 23, wherein an exposed surface of the implant forms a portion of the cutting surface.

30. The method of claim 23, wherein the implant is completely surrounded by the first carbide material.

31. The method of claim 23, wherein the at least one implant has a length that is not larger than 55% of the height of the cutting extension.
